(19) United States
(12) Patent Application Publication
(10) Pub. No.: US 2022/0103015 A1
(43) Pub. Date: Mar. 31, 2022

(54) Efficient Wireless Power Transfer Control

(71) Applicant: Apple Inc., Cupertino, CA (US)

(72) Inventors: Michael B. Nussbaum, Santa Cruz, CA (US); Katherine I. Pregler, Santa Clara, CA (US); Liang Chen, Auckland (NZ); Todd K. Moyer, Portland, OR (US); Bingyao Sun, Cupertino, CA (US)

(21) Appl. No.: 17/386,542

(22) Filed: Jul. 28, 2021

Related U.S. Application Data
(60) Provisional application No. 63/083,473, filed on Sep. 25, 2020.

(51) Int. Cl. H02J 50/12; H02J 50/80

(52) U.S. Cl. CPC H02J 50/12; H02J 50/80

(57) ABSTRACT

A wireless power transfer system can include a wireless power transmitter (PTx) and a wireless power receiver (PRx). The PTx can include a transmit coil driven by an inverter configured to receive an input DC voltage and provide an output AC voltage as a plurality of bursts. The PRx can include a receiver coil magnetically coupled to the transmit coil such that the bursts induce a corresponding AC voltage and a rectifier configured to receive the AC voltage and output a DC voltage to a load. The PRx can also include burst request pulse generation circuitry configured to operate the rectifier so as to deliver a burst request pulse to the PTx via magnetic coupling between coils. The PTx can further include inverter control circuitry configured to sense the burst request pulse and, in response thereto, trigger the inverter to deliver an AC voltage burst.

### BACKGROUND

Wireless power transfer, in which power is delivered via magnetic/inductive coupling between a power transmitter (PTx) and a power receiver (PRx), is becoming increasingly common. In some applications of wireless power transfer it may be desirable to provide operating efficiency greater than can be provided by current systems.

### SUMMARY

To improve overall operating efficiency of wireless power transfer systems, the wireless power transmitter may be operated in a burst mode, in which power is transmitted in short bursts, with an intervening period during which power is not transmitted. To facilitate operation of such systems, a wireless power receiver may be configured to deliver a Burst Request Pulse (BuRP) via the magnetic coupling between the receiver and the transmitter. Control circuitry in the transmitter may then deliver a power pulse. The control circuitry may determine the length of the pulse based at least in part on an elapsed time between BuRPs and optionally one or more other parameters received from the receiver via a higher latency communications path.

A wireless power transfer system can include a wireless power transmitter and a wireless power receiver. The wireless power transmitter can include an inverter having an input configured to receive an input DC voltage and an output configured to provide an output AC voltage as a plurality of bursts and a transmit coil coupled to an output of the inverter to receive the plurality of bursts. The wireless power receiver can include a receiver coil configured to magnetically couple to the transmit coil such that the plurality of bursts induce a corresponding AC voltage across the receiver coil and a rectifier having an input coupled to the receiver coil to receive the corresponding AC voltage from the receiver coil and an output configured to deliver a DC output voltage to a load. The wireless power receiver can further include burst request pulse generation circuitry configured to operate the rectifier so as to deliver a burst request pulse to the wireless power transmitter via magnetic coupling between the receiver coil and the transmit coil. The wireless power transmitter can further include inverter control circuitry configured to sense the burst request pulse and, in accordance with sensing the burst request pulse, trigger the inverter to deliver an AC voltage burst.

The burst request pulse generation circuitry can include circuitry configured to detect a valley of the DC output voltage and trigger one or more switching devices in the rectifier to couple the DC output voltage across the receiver coil. The rectifier may be a full bridge rectifier comprising a plurality of diodes and the one or more switching devices include a first switching device coupled in parallel with one of the plurality of diodes and a second switching device coupled in parallel with another of the plurality of diodes. The inverter control circuitry can include a burst request pulse sense and damping controller configured to detect the burst request pulse and initiate switching of the inverter in response thereto. The inverter control circuitry can further include a controller configured to determine one or more inverter switching parameters and provide those parameters to the burst request pulse sense and damping controller. The one or more inverter switching parameters can include one or more off time thresholds and one or more corresponding on times for the inverter. The wireless power receiver can still further include a communications transmitter configured to communicate data representing one or more of output voltage, output voltage ripple, and output current. The wireless power transmitter can still further include a communications receiver configured to receive the data from the communications transmitter. The communications receiver may be coupled to the inverter control circuitry and may be configured to update the one or more inverter switching parameters responsive at least in part to the received data representing one or more of output voltage, output voltage ripple, and output current from the communications transmitter.

A wireless power transmitter for a wireless power transfer system can include: (1) an inverter having an input configured to receive an input DC voltage and an output configured to provide an output AC voltage as a plurality of bursts, (2) a transmit coil coupled to an output of the inverter to receive the plurality of bursts, and (3) control circuitry configured to sense a burst request pulse and, in response thereto, trigger the inverter to deliver an AC voltage burst. The inverter control circuitry can include a burst request pulse sense and damping controller configured to detect the burst request pulse and initiate switching of the inverter in response thereto and a controller configured to determine one or more inverter switching parameters and provide those parameters to the burst request pulse sense and damping controller. The one or more inverter switching parameters can include one or more off time thresholds and one or more corresponding on times for the inverter. The wireless power transmitter can still further include a communications receiver configured to receive data representing one or more of output voltage, output voltage ripple, and output current from a communications transmitter disposed in a wireless power receiver. The communications receiver may be coupled to the inverter control circuitry, and the controller may be configured to update the one or more inverter switching parameters responsive at least in part to the received data representing one or more of output voltage, output voltage ripple, and output current from the communications transmitter. The control circuitry may be configured to switch one or more switching devices of the inverter to recover residual energy stored in a resonant tank of the inverter at the end of a burst. The control circuitry may also be configured to connect a damping resistor across a resonant tank of the inverter at the end of a burst to provide a quiet channel for sensing a burst request pulse.

A wireless power receiver for a wireless power transfer system can include: (1) a receiver coil magnetically coupled to the transmit coil such that the plurality of bursts induce a corresponding AC voltage across the receiver coil, (2) a rectifier having an input configured to receive the corresponding AC voltage from the receiver coil and an output configured to deliver a DC output voltage to a load, and (3) burst request pulse generation circuitry configured to operate the rectifier so as to deliver a burst request pulse to the wireless power transmitter via the magnetic coupling between the receiver coil and the transmit coil. The burst request pulse generation circuitry can include circuitry configured to detect a valley of the DC output voltage and trigger one or more switching devices in the rectifier to couple the DC output voltage across the receiver coil. The rectifier may be a full bridge rectifier comprising a plurality of diodes and the one or more switching devices can include a first switching device coupled in parallel with one of the plurality of diodes and a second switching device coupled in parallel with another of the plurality of diodes. The wireless power receiver can still further include a communications transmitter configured to communicate data representing one or more of output voltage, output voltage ripple, and output current to a corresponding communications receiver in a wireless power transmitter.

A method of controlling a burst mode wireless power transfer system having a wireless power transmitter with a transmit coil magnetically coupled to a receiver coil of a wireless power receiver can include (1) detecting a valley of an output voltage of the receiver and, responsive thereto, triggering a burst request pulse coupled from the receiver to the transmitter of via the magnetically coupled coils; and (2) responsive to the burst request pulse, initiating a burst of AC voltage in the transmitter that delivers power to the receiver via the magnetically coupled coils. The burst of AC voltage may have an adaptive constant on time. The adaptive constant on time may be determined by control circuitry in the wireless power transmitter, responsive at least in part to a time between burst request pulses. The adaptive constant on time may be determined by the control circuitry further responsive at least in part to at least one of an output voltage, output voltage ripple, and load current received by the control circuitry via a communications link having higher latency than a burst request pulse path.

### BRIEF DESCRIPTION OF THE DRAWINGS

FIG. 1 illustrates a high level schematic of a wireless power transfer system.

FIG. 2A illustrates a theoretical efficiency curve for a wireless power transfer system.

FIG. 2B illustrates efficiency and gain curves versus duty cycle for a wireless power transfer system with burst mode control.

FIG. 3 illustrates example waveforms of burst mode operation of a WPT system.

FIG. 4 illustrates a block diagram of a wireless power transfer system with burst mode control.

FIG. 5 illustrates a high level schematic of a wireless power receiver for generating burst request pules.

FIG. 6 illustrates control logic for a wireless power transfer system with burst mode control.

FIG. 7 illustrates switching states for an energy recovery mode at the end of a burst cycle in a wireless power transfer system with burst mode control.

FIGS. 8A and 8B illustrate various waveforms for an energy recovery mode at the end of a burst cycle in a wireless power transfer system with burst mode control.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

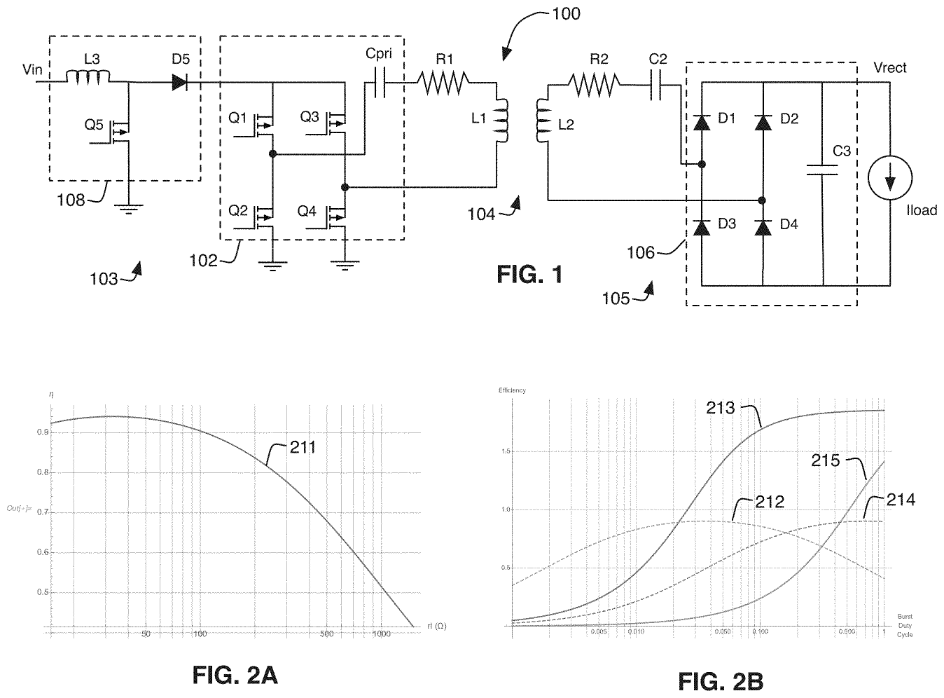

FIG. 1 illustrates a high level schematic of a wireless power transfer system 100. The left side of the figure illustrates a power transmitter (PTx) 103, which receives an input voltage Vin and transmits energy to a receiver via magnetic induction, i.e., by coupling between transmit and receive coils represented by inductors L1 and L2, respectively. (Each coil/inductor also has a corresponding intrinsic/parasitic resistance: R1/R2. These are illustrated in the schematic of FIG. 1 but are not separate physical components.) The right side of the figure depicts a power receiver (PRx) 105 that receives power via the aforementioned magnetic coupling and delivers power to a load depicted by current source Iload. In the illustrated example, PTx 103 includes a boost regulator 108 that provides voltage regulation for the system as described in greater detail below. More specifically, boost regulator 108 receives an input voltage Vin and converts it to a regulated voltage that is supplied to inverter 102. Inverter 102 generates an AC output having a predetermined frequency and a magnitude that is determined by boost regulator 108. This AC output voltage is provided the transmit coil, represented by inductor L1, which is magnetically coupled a corresponding receive coil, represented by inductor L2. This results in energy transfer to the PRx 105. PRx 105 includes a receive coil, represented by inductor L2, which has a voltage induced therein by magnetic induction via transmit coil L1. This AC voltage may be provided to a rectifier 106, discussed in greater detail below, that converts the received AC voltage to an output DC voltage (Vrect) that may be supplied to a load. The wireless power transfer system 100 may include additional components, such as transmitter tuning capacitor Cpri and receiver tuning capacitor C2 that may be used to tune the resonant frequency of the transmit and receive circuits to improve operating efficiency of the system.

In the illustrated embodiment, inverter 102 is a full bridge inverter made up of four switching devices Q1-Q4, although other inverter topologies could be used as appropriate for a given application. These switching devices are illustrated as MOSFETs (metal-oxide-semiconductor field effect transistors), though other types switching devices (including, for example, IGBTs (insulated gate bipolar transistors), junction field effect transistors (JFETs), etc. could be used as appropriate for a given embodiment. Likewise, any suitable semiconductor technology, such as silicon, silicon carbide (SiC), gallium nitride (GaN), could be used depending on the specific application. The same applies to all other switching devices (including diodes) discussed in the present application. Switching devices Q1-Q4 may be alternately switched to connect an input DC voltage (e.g., from boost regulator 108) to the transmit winding L1, producing an AC voltage that may be coupled to the PRx as described above.

Operation of inverter 102 will induce an AC voltage in magnetically coupled PRx receiver coil L2. This AC voltage may be coupled to a rectifier 106. In the illustrated embodiment, rectifier 106 is a full bridge rectifier made up of four diodes D1-D4. Although illustrated as conventional rectifier diodes, other rectifier types, such as Schottky diodes might be appropriate for some applications. Other rectifier configurations could also be used, including, for example, synchronous rectifier configurations in which the diodes are replaced with active switching devices such as MOSFETs, Bipolar transistors, or SCRs (silicon controlled rectifiers), etc. Any of the foregoing devices may be constructed using any suitable semiconductor technology. These alternative configurations can provide for increased operating efficiency in some applications.

Boost regulator 108 may be used to provide voltage regulation for the system. More specifically, the voltage supplied to inverter 102 will ultimately determine the output voltage (Vrect), depending, of course, on the coupling coefficient between the transmit and receive coils and the various other circuit components. Nonetheless, for a given embodiment, implementation, and/or configuration, increasing or decreasing the voltage supplied to the inverter will result in a corresponding increase or decrease in output voltage Vrect. Thus, a suitable feedback system can allow for output voltage regulation using boost regulator 108. In some embodiments, other regulator types may be substituted for boost regulator 108. In still other embodiments, a regulator could be provided at another location in the power chain. Nonetheless, the basic principles described above will hold. In all of these embodiments, regulator 108 introduces some inefficiencies into the system. For example, a boost converter may operate with efficiencies between 85% and 95%, depending on the particular application.

For wireless power transfer systems like those described above, it can be determined that the AC-AC efficiency of the system is a function of the load resistance, i.e., the ratio of Vrect to Iload. FIG. 2 illustrates an exemplary efficiency curve 211 versus load resistance. The specifics of the efficiency curve will vary depending on the implementation particulars of a given system, but the basic principle holds. As illustrated in FIG. 2, there will be a peak efficiency, corresponding to a single value of the load resistance, with efficiency falling off for other values. In applications in which the wireless power transfer system is used for battery charging, the system may be designed so that peak efficiency is achieved at a relatively high load, corresponding to a relatively low output resistance. This might correspond to the beginning of a battery charging cycle, in which a relatively high constant current may be supplied to the battery. However, as a result of the foregoing optimization, when operating at lower load conditions, such as when charging rate substantially slows toward the end of the charging cycle (corresponding to a light load condition), the system will be less efficient.

The inventors of the present application have determined that operating a wireless power transfer system in a burst mode can address inefficiencies associated with regulator stage 108 and with operation at loading conditions other than the one output resistance point for which the system is optimized. In burst mode, power is transmitted in short bursts instead of in a continuous stream. Thus, a burst can include one or more AC pulses from the inverter. Following the one or more burst pulses, there may be an intervening time period during which no AC power is transmitted. This intervening time period may then be followed by another burst of one or more AC pulses. This can mitigate light loads light load inefficiencies by decreasing switching losses and quiescent current losses. Additionally, carefully controlled use of burst mode can allow the system to effectively be loaded at its optimum output resistance, thus allowing the AC/AC system to be operated at or near its peak efficiency, regardless of actual output power. Finally, the use of burst mode can be used to control the voltage gain of the system, i.e., the ratio of the output voltage Vrect to the input voltage Vin. This can allow for elimination of the boost regulator stage 108, as described in greater detail below.

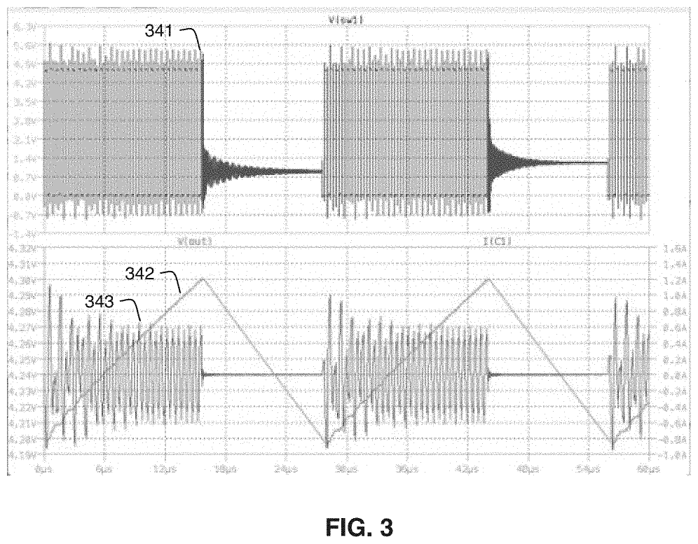

FIG. 3 shows example waveforms of burst mode operation of a WPT system. Waveform 341 shows one of the switch nodes of the inverter corresponding to the junction of switches Q1 and Q2 in FIG. 1. Waveform 342 shows the output voltage Vrect. Waveform 343 shows the primary coil current. It can be seen that when power transfer is active (i.e., during a burst) the output voltage 342 rises. When power transfer pauses, the output voltage Vrect decays, as the load is being drawn from the output capacitor C3. The burst mode may be characterized by an effective duty cycle D, where:

$$D = \frac{Ton}{Ton + Toff} .$$

It can be shown that the duty cycle D modulates the load resistance, giving an effective load resistance according to:

Rl_{effective}=RlD.

Thus, for any load resistance Rl>Rloptimum, through the use of duty cycle control, the wireless power transfer system can effectively operate the system at Rloptimum.

However, as can be seen from the Vrect waveform 342 in FIG. 3, the use of burst mode results in a ripple waveform in the output voltage Vrect. If the load is a switching converter this ripple is not a problem (so long as the minimum and maximum input voltage limits of the converter are respected). Thus, system efficiency will not be substantially adversely affected by this ripple. However, if the load is a linear regulator, efficiency may be adversely affected. Thus, for at least some embodiments, it may be desirable to minimize the output ripple by control of the on time (which will control burst frequency) as described in greater detail below.

Another effect of burst mode is that it gives an additional method to control the gain of the WPT system. FIG. 2B shows two exemplary output voltage gain versus burst duty cycle curves.

More specifically, FIG. 2B shows curves illustrating conversion gain and efficiency versus burst duty cycle. Curves 212 and 213 represent efficiency and voltage conversion gain, respectively for a first, relatively higher, output resistance. Curves 214 and 215 represent efficiency and voltage conversion gain, respectively for a second, relatively lower, output resistance. With respect to the first, relatively higher output resistance, peak efficiency occurs around 4% duty cycle, with voltage gain initially increasing slowly, then increasing at a greater rate, before beginning to taper off around a duty cycle of 10%. With respect to the second, relatively higher output resistance, peak efficiency occurs around a duty cycle of 50%, with voltage gain initially increasing slowly, then beginning to increase more rapidly around a duty cycle of 10%. The illustrated curves are exemplary for certain conditions, and the exact efficiency peaks and gains can be selected as desired by a system designer. However, in both examples, it can be seen that the system may be operated relatively near peak operating efficiency with relatively small changes in duty cycle resulting in significant changes in voltage conversion gain. This can allow for omission of the regulator stage 108 discussed above.

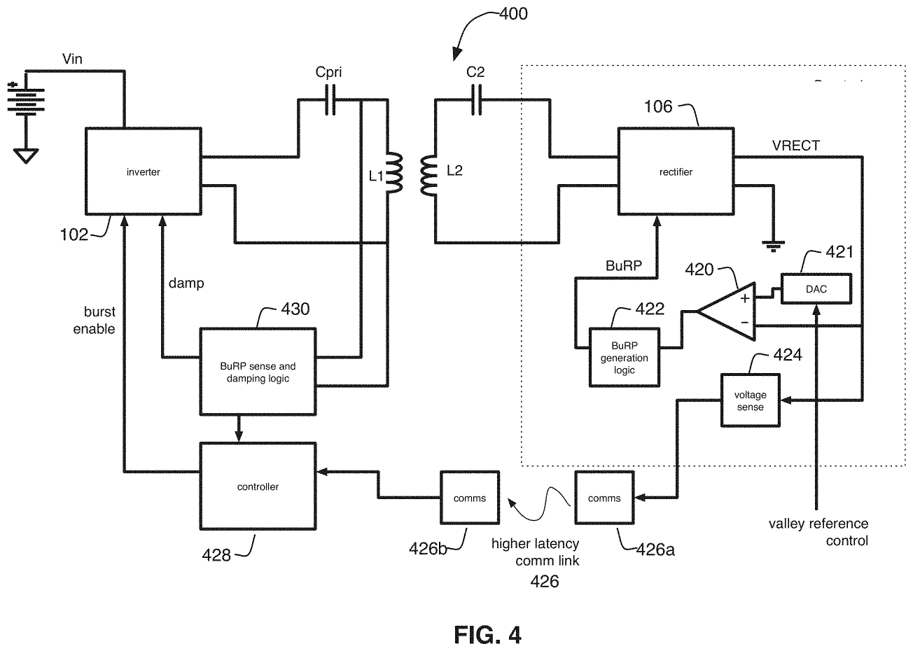

FIG. 4 illustrates an exemplary embodiment of a wireless power transfer system 400 implementing burst mode control. The power train of wireless power transfer system 400 is similar to that discussed above, with the omission of the boost converter, 108. An input voltage Vin is supplied to an inverter 102. Inverter 102 generates an AC voltage that is provided to transmit coil L1 via primary tuning capacitor Cpri. This induces a corresponding AC voltage in receiver coil L2, which provides this AC voltage to rectifier 106 via secondary tuning capacitor C2. Rectifier 106 converts the induced AC voltage into a DC voltage VRECT, which may be supplied to a load, not shown.

The lower portion of FIG. 4 illustrates exemplary control circuitry for operating the wireless power transfer system 400 in a burst mode as described above with reference to FIG. 3. As was noted above, operating inverter 102 in a burst mode causes a ripple in output voltage VRECT, with VRECT increasing when inverter 102 is operating and decreasing when inverter 102 is not operating. By determining a suitable lower limit for VRECT, i.e., a valley of the ripple, and determining when the output voltage valley is reached, a burst of pulses may be triggered. In some embodiments, this valley reference signal may be adapted based on load conditions on the receiver side and may thus be considered as the primary set point of the regulation system.

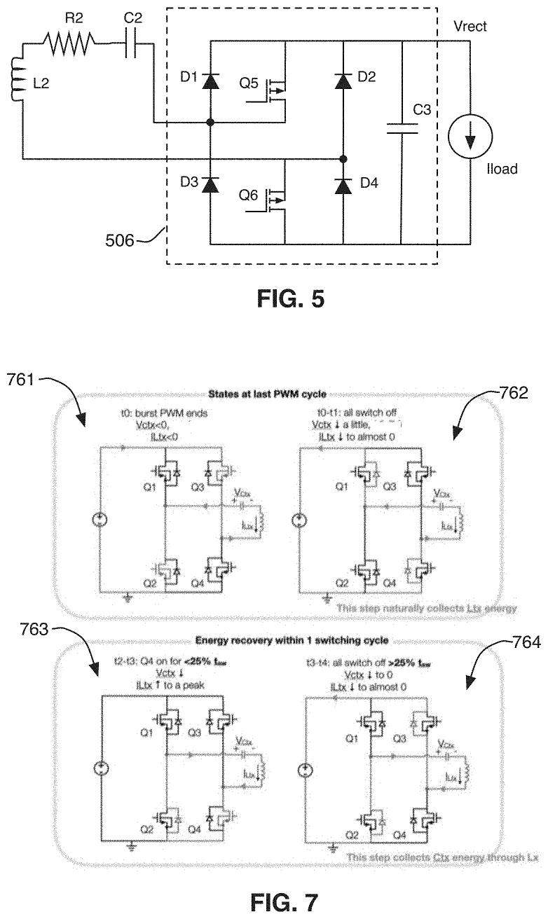

To that end, a valley reference control value may be provided to digital to analog converter 421, which may provide a corresponding analog value to one input of comparator 420. The output voltage VRECT may be coupled to the other input of comparator 420, such that comparator 420 generates a trigger signal when VRECT falls to the valley reference value. The trigger signal output of the comparator may be provided to Burst Request Pulse (BuRP) generation logic 422, which may then trigger rectifier 106 to generate a burst request pulse as described in greater detail below with reference to FIG. 5. BuRP generation logic may include any suitable combination of digital, analog, or programmable circuitry that can receive the valley detection trigger signal from comparator 420 and thereby cause rectifier 106 to generate a Burst Request Pulse (BuRP).

FIG. 5 illustrates a simplified schematic diagram of the receiver (PRx) side of wireless power transfer system 400. More specifically, rectifier 506 has been expanded to show a full bridge rectifier, made up of diodes D1-D4 that receives the induced AC voltage from receiver coil L2 and generates an output DC voltage Vrect. Rectifier 506 also has synchronous rectifier switches Q5 and Q6 that are coupled in parallel with diodes D1 and D4. Drive circuitry (not shown) may be coupled between BuRP generation logic 422 (FIG. 4) and switches Q5 and Q6 to generate a burst request pulse that may couple to the primary side, providing an indication to the primary side control circuitry that a burst pulse is required. More specifically, when BuRP generation logic 422 requests a burst pulse, switches Q5 and Q6 may be closed, temporarily coupling Vrect across receiver coil L2. This induces a corresponding pulse that may be detected across transmit coil L1 (FIG. 4) as described in greater detail below.

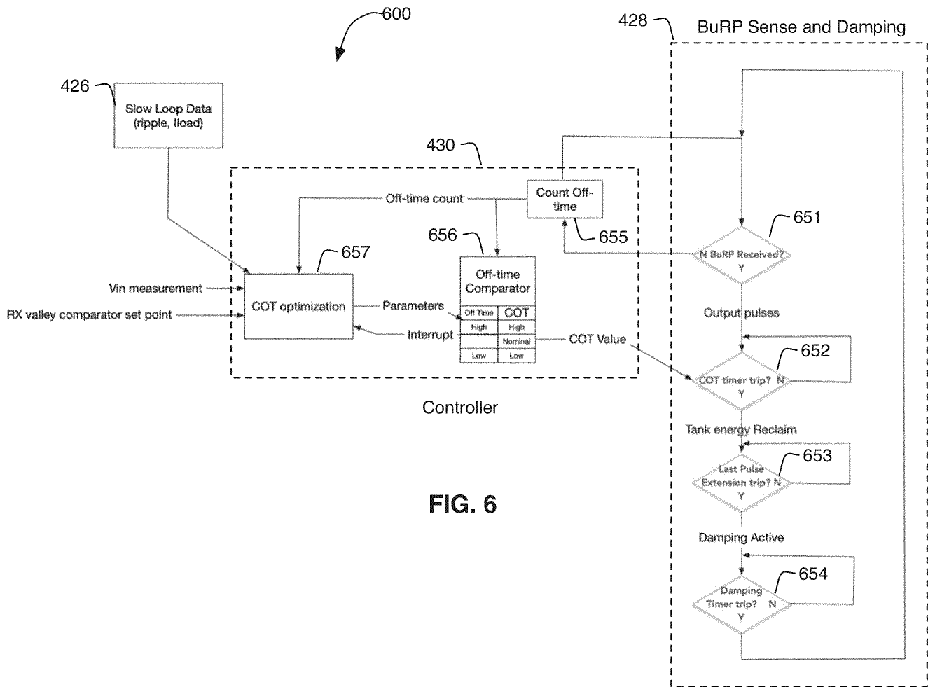

Turning back to FIG. 4, the Burst Request Pulse (BuRP) generated by rectifier 106 may couple into transmitter coil L1, where it may be detected by sense and damping logic 430. Sense and damping logic 430 may include circuitry implemented with any suitable combination of digital, analog, and/or programmable components to detect the BuRP and trigger inverter controller 428 to cause inverter 102 to begin operating to provide the requested burst of operation. Controller 428 may be any suitable combination of analog, digital, or programmable circuitry that can control the operation of inverter 102. Controller 428 may also be configured to regulate the on-time of the bursts responsive to the time between BuRPs, as described in greater detail below with respect to FIG. 6.

The BuRP control technique described above can provide an extremely fast response to the detection of the valley of output voltage VRECT, and therefore provide for a highly responsive control system. By analyzing the timing of the BuRPs, the primary side control circuitry can even estimate load current and output ripple voltage. However, these estimates may be further refined, or calibrated, by reference to additional information sent from the receiver side to the primary side. For example, output voltage VRECT may be measured by a voltage sensor 424 and provided to a transmitter 426a (part of power receiver PRx) of a communications link with the power transmitter PTx. Likewise, the output voltage ripple and the output current can be measured as well and sent to the power transmitter.

Communications link 426 may be embodied using a variety of different technologies, including communications technologies that exhibit significantly higher latency than the BuRP path described above. This could be some out-of-band communications protocol, such as 10.6 MHz NFMI, coupled over the wireless power coil itself, or a separate inductive link. In other embodiments, the communications signal may use a separate physical channel from the wireless power link, such as a WiFi, NFC, Bluetooth, or other wireless link.

The power transmitter (PTx) may include a corresponding higher latency communications receiver 426b that may receive the PRx side information from transmitter 426a. This information may then be provided to controller 428, which may use it to calibrate its estimates of load voltage ripple, and load current. It can then use this information to adjust the burst on time, which will change the burst frequency and output ripple. Thus communications path 426 provides for a “slow loop,” i.e., a control loop that is slower than the BuRP path described above that can serve as a calibrator for the faster BuRP loop.

FIG. 6 illustrates a block diagram depicting the operation of BuRP sense and damping logic 430 and controller 428, which may be configured to trigger burst pulses of inverter 102 responsive to a BuRP signal received from rectifier 106. In any given implementation, BuRP sense and damping logic 430 and inverter controller 428 may be integrated into a single controller or may be constructed separately, and thus the described separate implementation should be considered exemplary and non-limiting. BuRP sense and damping logic 428 may execute a control loop corresponding to the flow chart illustrated on the right side of FIG. 6. Specifically, at block 651, the BuRP Sense and Damping logic 428 may determine whether a BuRP has been received. If not, then an off time counter 655, which may be part of controller 430 may increment, and BuRP sense and damping logic 428 may continue waiting for a BuRP.

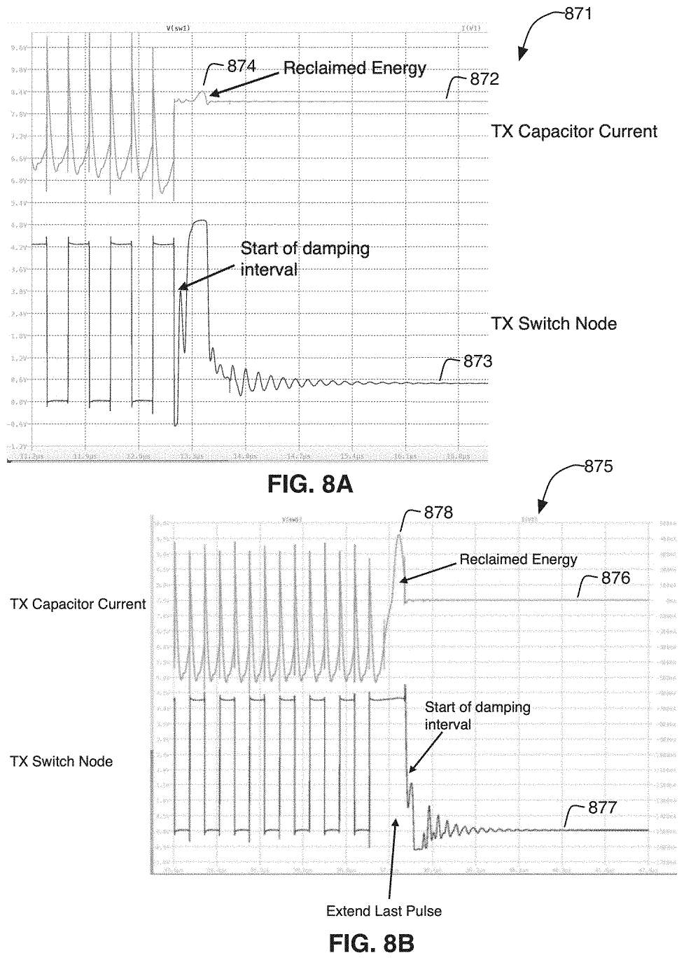

Once the BuRP is received, inverter 102 may be triggered to generate a series of pulses. The time for which these pulses are generated, i.e., the on-time, may be determined by controller 430 using a constant on-time (COT) control technique, as described in greater detail below. For understanding of BuRP Sense and Damping controller 428, it is sufficient to understand that an on-time value, i.e., COT value, may be provided to BuRP sense and damping circuit 428, and specifically to the COT timer trip logic 652. If the inverter has not been generating pulses for sufficient time to trip the COT timer, the inverter will continue to generate pulses. Once the COT timer has tripped, i.e., the inverter has been operating for the COT value specified by controller 430, inverter operation may be stopped. Stopping of inverter operation may include an optional tank energy reclamation scheme as described in greater detail below with respect to FIGS. 7 and 8.

Also as part of the stopping of inverter operation, it may be determined whether the last pulse extension trip has been completed (block 653) and whether the damping timer has tripped (block 654). These functions are described in greater detail below with respect to FIGS. 7 and 8. For purposes of understanding the control operation depicted in FIG. 6, it is sufficient to understand that timers may be implemented to allow for energy recovery and quieting of the power transfer channel, so that a BuRP pulse may be detected on the primary winding. Energy recovery may involve extensions of switching after the termination of the burst as described with respect to FIG. 7 to recover residual energy in the LC tank made up of primary capacitance Cpri and transmit coil L1. The damping time period can include temporarily and selectively coupling a resistance across the tank to dissipate any remaining energy stored in the resonant tank that was not recovered to the input. After the expiration of these timers associated with this operation, operation of BuRP sense and damping circuit 428 returns to block 651 discussed above.

Turning now to controller 430, as was noted above, BuRP sense and damping circuit 428 can provide input for an off time counter 655 that effectively determines the length of time between BuRPs from the receiver side. This off time count may be provided to an off time comparator 656 that specifies the constant on-time value provided to the BuRP sense and damping circuit 428. Off-time comparator 656 is thus part of the “fast” control loop referenced above, with the BuRP pulse itself being the rest of the fast loop. The off time count may also be provided to a COT (constant on time) optimization module 657 that provides various COT values to the off-time comparator 656. COT optimization module 657 is thus the “slow” control loop referenced above.

Off-time comparator may include circuitry or programmed logic configured to provide one of a plurality of on-time values for the burst pulse responsive to the time between BuRPs as determined by off time counter 655. As one example, off time comparator 656 may have a high threshold and a low threshold for off time. If the time between BuRPs exceeds the high threshold, meaning a longer time between BuRPs corresponding to a relatively lighter load condition, then a corresponding (shorter) COT value may be provided to the COT timer implemented by BuRP sense and damping circuit 428. (FIG. 6 denotes a the COT value as “high” for the lighter load condition, although this is high in the sense of corresponding to a longer time between BuRPs, but is lower or shorter in terms the corresponding on time.) Conversely, if the time between BuRPs is less than the low threshold, meaning a shorter time between BuRPs corresponding to a relatively higher load condition, then a corresponding (longer) COT value may be provided to the COT timer implemented by BuRP sense and damping circuit 428. (FIG. 6 denotes a the COT value as “low” for the higher load condition, although this is low in the sense of corresponding to a shorter time between BuRPs, but is higher or longer in terms of the corresponding on time.) Finally, if the time between BuRPs falls between the high and low thresholds, meaning a nominal time between BuRPs corresponding to nominal load condition, then a corresponding nominal COT value may be provided by the COT timer implemented by BuRP sense and damping circuit 428. In this way, for nominal load conditions, a suitable constant on-time for the inverter pulses may be provided, and the on time may be adapted as appropriate in response to changing (i.e., increasing or decreasing) load conditions. Controller 430 may thus be considered to be an adaptive constant on-time controller.

As described above, off-time comparator 656 can provide one of three on-times for a burst sequence responsive to a comparison of the off-time between pulses to a pair of high thresholds. This operation corresponds to five parameters provided to off-time comparator 656 by COT optimization block 657, i.e., a high off time threshold and corresponding COT value, a low off time threshold and a corresponding COT value, and a nominal COT value. In some embodiments, other numbers of parameters and thresholds could be provided. For example, four thresholds, corresponding to high-high, high, nominal, low, and low-low off times could be provided, with five corresponding constant on-times. In any case, the off-time comparison thresholds and the corresponding on-times may be provided to off-time comparator 656 by COT optimization block 657. Default parameters may be provided at startup of the control system and updates to these parameters may be provided to adapt them as appropriate during operation. For example, at any time that off-time comparator 656 provides either a high or low COT value, responsive to a decrease or increase in load, off-time comparator 656 may also provide an interrupt to COT optimization block, which may in response provide updated parameters, which may be tuned by the slow control loop as described in greater detail below.

As noted above, wireless power transfer system 400 may include a higher latency communications link 426 that can provide receiver side information, such as output voltage information, to the inverter controller 428. Although the higher latency of this loop may be less suitable than the fast BuRP path for real time control of wireless power transfer system 400, the additional information that may be provided by comms link 426 may be advantageously used to tune the COT parameters provided to off-time comparator 656. More specifically, the inventors of the present application have determined that, for a wireless power transfer system operating in burst mode, the output current can be determined by the equation:

Iout=BurstDuty(K₁Vout+{square root over (K₂Vin²+K₃Vout²))}

where Tout is the output current, BurstDuty is the burst duty cycle (as defined above), Vout is the output voltage (i.e., VRECT), and Vin is the input voltage (see FIG. 4), and K1, K2, and K3 are constants that correspond to the circuit parameters (e.g., L1, R1, C1, L2, R2, and C2 as shown in FIG. 1) of the wireless power transfer system and the coupling coefficient K between transmit coil L1 and receive coil L2. The nominal values of these circuit parameters are known, and the slow control loop can be used to ascertain more specific values. More specifically, COT optimization block 657 of controller 430 may receive a measurement of input voltage Vin (which is readily available on the PTx side). Additionally, controller 428/COT optimization block 657 knows the duty cycle because it receives an off time count from off time counter 655 and determines the on-time(s) used by off time comparator 656, the duty cycle being defined as: COT/(COT+off_time). Finally, output voltage ripple and current may be received by controller 430/COT optimization block 657 via the high latency comms path/slow loop 426. The constants K1, K2, and K3 may be derived by the controller in response to a series of measurements, e.g., using a regression analysis. Once known, these constants may be used to tune the parameters provide to off-time comparator in response to load conditions. That is, high and low off time thresholds and corresponding constant on-time values may be computed to achieve a desired burst frequency or acceptable ripple voltage for a given load condition. These updated values may be provided periodically or in response to the aforementioned interrupt.

As briefly mentioned above, termination of a power transfer burst at the end of the specified adaptive constant on time interval may be followed by an energy recovery period that allows energy stored in the resonant tank circuit made up of the transmit coil L2 and the primary capacitance Cpri to be recovered to the input power source, thereby improving the overall operating efficiency of the system. FIG. 7 illustrates on exemplary switching scheme that may be executed at the end of the burst cycle to facilitate such energy recovery. Circuit diagram 761 corresponds to the end of the burst state, with switches Q2 and Q3 closed. This provides the negative phase of the AC waveform, as current flows from the input source, through closed switch Q3, up through transmit coil L1 and capacitor Cpri, returning to the input through closed switch Q2. This results in negative voltage VCtx across Cpri and a negative current ILtx through transmit coil L1 according to the sign convention illustrated.

At the termination of the burst, switches Q2 and Q3 are turned off, as illustrated in circuit diagram 762. However, because the current through the transmit coil (an inductor) cannot change instantaneously, current continues to flow through the intrinsic body diodes of switches Q1 and Q4. (If the inverter is implemented using switching devices without intrinsic body diodes, suitable antiparallel diodes may be provided to facilitate the operations described herein.) This allows the energy stored in the transmit coil inductance to be recovered to the DC input source. During this same interval, a portion of the energy stored in the capacitor will also be recovered. The duration of this state may be selected to be long enough for the inductor current ILtx to decay to zero based on the values and tolerances of Cpri and L1 and the magnitude of VCtx and ILtx at the end of the burst. In some embodiments, 50% of the inverter switching period could be an upper limit for the duration of this state.

Once the current has decayed to approximately zero, e.g., has decayed below a predetermined threshold, switch Q4 may be turned on as illustrated in circuit diagram 763. In some embodiments, switch Q4 may be turned on for a time period that is less than about 25% of the overall switching period of the inverter. This allows the energy stored in the primary capacitor to force a current in the opposite direction (i.e., positive in the sign convention shown), which has the effect of transferring the energy stored in the primary capacitor into the transmit coil inductor. This forced current flows from the primary capacitor, through the transmit winding, through turned on switch Q4, returning to the capacitor through the intrinsic body diode of switch Q2. This state may end with Q4 turned off by the inverter controller just before the capacitor voltage decreases to 0. At this moment, a portion of the energy in the capacitor Cpri will have been transferred to the transmit coil. As noted above, this state should take less than about 25% of the inverter switching period.

Once switch Q4 has been turned off, the positive current in the inductance of the transmit coil will tend to continue. As illustrated in circuit diagram 764, this current will flow through the intrinsic body diodes of switches Q1 and Q3, returning the above-described portion of the energy previously stored in the primary capacitor, now stored in the transmit coil inductor, to the input as shown. At the same time, the inductor current is further discharging the primary capacitor so that the rest of the capacitor energy is also returned to the input source. This state may also be designed to be long enough for ILtx to decay to 0. One-half (50%) of the inverter switching period may be an upper limit for the time duration of this state. This sequence of operation allows substantially all of the energy stored in the resonant tank circuit to be recovered to the input power source within a relatively short period of time (e.g., one and one half cycles) following termination of the burst pulse. This energy reclamation can take place in the interval indicated in FIG. 6 between blocks 652 and 653, which can be set by a predetermined time delay.

FIGS. 8A and 8B illustrate the effect of an energy recovery period as described above and also illustrate the damping interval required to ensure a quiet power transfer channel that will allow for the detection of subsequent BuRPs. FIG. 8A depicts the end of a burst without the energy reclamation technique described with respect to FIG. 7. Upper graph 871 depicts a plot 872 of the current through the primary capacitor Cpri and a plot 873 of the voltage at the switch node corresponding to the junction of switches Q1 and Q2 (FIG. 1). As can be seen only a small portion of the residual energy is able to be reclaimed, corresponding to peak 874. FIG. 8B depicts the end of a burst with the energy reclamation technique described with respect to FIG. 7. Upper graph 875 depicts a plot 876 of the current through the primary capacitor Cpri and a plot 877 of the voltage at the switch node corresponding to the junction of switches Q1 and Q2 (FIG. 1). As can be seen a significantly greater portion of the residual energy is able to be reclaimed, corresponding to peak 878.

In both cases, the start of the damping interval is depicted on the switch node voltage plots (i.e., plots 873 and 877). It will be appreciated that merely turning off the inverter at the end of a constant on time period would result in an extended ring down of the LC tank made up of primary capacitance Cpri and the transmit coil L2. However, this ringing could interfere with the detection of the BuRP described above. Thus, a damping interval may be provided in which a resistor is connected across the LC tank to dissipate the energy stored therein. In plot 873, in which energy recovery like in FIG. 7 is not used, the damping of the voltage includes a higher magnitude ringing, associated with the greater energy that must be dissipated during the damping phase. In plot 877, in which energy recover like in FIG. 7 is used, there is a slightly longer final pulse (corresponding to the above-described switching), with a following damping interval. As a result, the damping has a much smaller ringing magnitude, because of the lower energy to be dissipated (because of the energy that is reclaimed in the extended final pulse).

The foregoing describes exemplary embodiments of wireless power transfer systems incorporating burst mode control to allow for improved operating efficiency. Such systems may be used in a variety of applications but may be particularly advantageous when used in conjunction with wireless power transfer systems in which a power or energy limited source (such as a battery) is used to inductively power another system, such as might be the case when a mobile phone or other wireless device is used to charge a wireless accessory. However, any wireless power transfer system for which increased overall efficiency is desired may advantageously employ the techniques described herein. Although numerous specific features and various embodiments have been described, it is to be understood that, unless otherwise noted as being mutually exclusive, the various features and embodiments may be combined in various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A wireless power transfer system comprising:
a wireless power transmitter including:
an inverter having an input configured to receive an input DC voltage and an output configured to provide an output AC voltage as a plurality of bursts;
a transmit coil coupled to an output of the inverter to receive the plurality of bursts; and
a wireless power receiver including:
a receiver coil configured to magnetically couple to the transmit coil such that the plurality of bursts induce a corresponding AC voltage across the receiver coil;
a rectifier having an input coupled to the receiver coil to receive the corresponding AC voltage from the receiver coil and an output configured to deliver a DC output voltage to a load;
wherein the wireless power receiver further comprises burst request pulse generation circuitry configured to operate the rectifier so as to deliver a burst request pulse to the wireless power transmitter via magnetic coupling between the receiver coil and the transmit coil; and
wherein the wireless power transmitter further comprises inverter control circuitry configured to sense the burst request pulse and, in accordance with sensing the burst request pulse, trigger the inverter to deliver an AC voltage burst.

2. The wireless power transfer system of claim 1 wherein the burst request pulse generation circuitry comprises circuitry configured to detect a valley of the DC output voltage and trigger one or more switching devices in the rectifier to couple the DC output voltage across the receiver coil.

3. The wireless power transfer system of claim 2 wherein the rectifier is a full bridge rectifier comprising a plurality of diodes and the one or more switching devices include a first switching device coupled in parallel with one of the plurality of diodes and a second switching device coupled in parallel with another of the plurality of diodes.

4. The wireless power transfer system of claim 1 wherein the inverter control circuitry comprises a burst request pulse sense and damping controller configured to detect the burst request pulse and initiate switching of the inverter in response thereto, and a controller configured to determine one or more inverter switching parameters and provide those parameters to the burst request pulse sense and damping controller.

5. The wireless power transfer system of claim 4 wherein one or more inverter switching parameters include one or more off time thresholds and one or more corresponding on times for the inverter.

6. The wireless power transfer system of claim 4 wherein:
the wireless power receiver further comprises a communications transmitter configured to communicate data representing one or more of output voltage, output voltage ripple, and output current; and
the wireless power transmitter further comprises a communications receiver configured to receive the data from the communications transmitter.

7. The wireless power transfer system of claim 6 wherein:
the communications receiver is coupled to the inverter control circuitry; and
the controller is configured to update the one or more inverter switching parameters responsive at least in part to the received data representing one or more of output voltage, output voltage ripple, and output current from the communications transmitter.

8. A wireless power transmitter for a wireless power transfer system comprising:
an inverter having an input configured to receive an input DC voltage and an output configured to provide an output AC voltage as a plurality of bursts;
a transmit coil coupled to an output of the inverter to receive the plurality of bursts; and
control circuitry configured to sense a burst request pulse and, in response thereto, trigger the inverter to deliver an AC voltage burst.

9. The wireless transmitter of claim 8 wherein the inverter control circuitry comprises a burst request pulse sense and damping controller configured to detect the burst request pulse and initiate switching of the inverter in response thereto and a controller configured to determine one or more inverter switching parameters and provide those parameters to the burst request pulse sense and damping controller.

10. The wireless power transmitter of claim 9 wherein one or more inverter switching parameters include one or more off time thresholds and one or more corresponding on times for the inverter.

11. The wireless power transmitter of claim 9 further comprising a communications receiver configured to receive data representing one or more of output voltage, output voltage ripple, and output current from a communications transmitter disposed in a wireless power receiver.

12. The wireless power transmitter of claim 11 wherein:
the communications receiver is coupled to the inverter control circuitry; and
the controller is configured to update the one or more inverter switching parameters responsive at least in part to the received data representing one or more of output voltage, output voltage ripple, and output current from the communications transmitter.

13. The wireless power transmitter of claim 8 wherein the control circuitry is configured to switch one or more switching devices of the inverter to recover residual energy stored in a resonant tank of the inverter at the end of a burst.

14. The wireless power transmitter of claim 8 wherein the control circuitry is configured to connect a damping resistor across a resonant tank of the inverter at the end of a burst to provide a quiet channel for sensing a burst request pulse.

15. A wireless power receiver for a wireless power transfer system comprising:
a receiver coil magnetically coupled to the transmit coil such that the plurality of bursts induce a corresponding AC voltage across the receiver coil;
a rectifier having an input configured to receive the corresponding AC voltage from the receiver coil and an output configured to deliver a DC output voltage to a load; and
burst request pulse generation circuitry configured to operate the rectifier so as to deliver a burst request pulse to the wireless power transmitter via the magnetic coupling between the receiver coil and the transmit coil.

16. The wireless power receiver of claim 15 wherein the burst request pulse generation circuitry comprises circuitry configured to detect a valley of the DC output voltage and trigger one or more switching devices in the rectifier to couple the DC output voltage across the receiver coil.

17. The wireless power receiver of claim 16 wherein the rectifier is a full bridge rectifier comprising a plurality of diodes and the one or more switching devices include a first switching device coupled in parallel with one of the plurality of diodes and a second switching device coupled in parallel with another of the plurality of diodes.

18. The wireless power receiver of claim 15 further comprising a communications transmitter configured to communicate data representing one or more of output voltage, output voltage ripple, and output current to a corresponding communications receiver in a wireless power transmitter.

19. A method of controlling a burst mode wireless power transfer system having a wireless power transmitter having a transmit coil magnetically coupled to a receiver coil of a wireless power receiver, the method comprising:
detecting a valley of an output voltage of the receiver and, responsive thereto, triggering a burst request pulse coupled from the receiver to the transmitter of via the magnetically coupled coils; and
responsive to the burst request pulse, initiating a burst of AC voltage in the transmitter that delivers power to the receiver via the magnetically coupled coils.

20. The method of claim 20 wherein the burst of AC voltage has an adaptive constant on time.

21. The method of claim 20 wherein the adaptive constant on time is determined by control circuitry in the wireless power transmitter, responsive at least in part to a time between burst request pulses.

22. The method of claim 21 wherein the adaptive constant on time is determined by the control circuitry further responsive at least in part to at least one of an output voltage, output voltage ripple, and load current received by the control circuitry via a communications link having higher latency than a burst request pulse path.
